(19) United States
(12) Patent Application Publication
(10) Pub. No.: US 2006/0197661 A1
(43) Pub. Date: Sep. 7, 2006

(54) Alarm having illumination feature

(75) Inventors: Larry Tracy, Auburn, CA (US); Kiyoshi Nagaya, Yokohama (JP); Hironori Yasuda, Yokohama (JP)

Correspondence Address: DLA PIPER RUDNICK GRAY CARY US, LLP, 2000 UNIVERSITY AVENUE, E. PALO ALTO, CA, 94303-2248, US

(73) Assignee: Inet Consulting Limited Company

(21) Appl. No.: 11/063,417

(22) Filed: Feb. 22, 2005

(51) Int. Cl. G08B 13/00; G08B 29/00; G08B 17/12

(52) U.S. Cl. 340/541; 340/506; 340/600

(57) ABSTRACT

An improved alarm system that has an added illumination feature allowing locations to be both scanned for intruders, and illuminated upon intrusion detection. This illumination feature imparts a number of advantages over current alarm systems. Notably, lighting the area where an intrusion is detected can aid in identifying the intruder and possibly even intimidating him/her into leaving, especially during night time or other conditions of low ambient light. Also, the illumination feature can be configured so as to be activated independent of the alarm itself. In this manner, light can be provided during emergencies or any other time that users require additional light.

### BRIEF DESCRIPTION OF THE INVENTION

This invention relates generally to alarm systems. More specifically, this invention relates to alarm systems having illumination features.

### BACKGROUND OF THE INVENTION

Conventional alarm systems, such as passive infrared (PIR) intrusion detectors, see extensive use for detecting and deterring intrusions such as break-ins or trespasses. One such alarm system is shown in block diagram form in FIG. 1. Here, an alarm system 10 has an alarm circuit 20 with a detection element 30 that detects intrusions, a controller 40 programmed to trigger an alarm upon the detection of an intrusion, and a loudspeaker 50 for sounding an alarm accordingly. The detection element 30 can be any device for detecting intrusion. For instance, it can be a PIR detector capable of detecting infrared radiation given off by potential intruders. The detection element 30 can also be a microwave detector, a photo beam detector, a glass break sensor, a door contact sensor, or any other sensing element capable of being employed to detect an intrusion.

In operation, the detection element 30 is placed in proximity to the location at which intrusions are to be detected/prevented. Upon detecting an intrusion (e.g., upon detecting motion), the detection element 30 transmits a signal through the amplifier/filter 60 and to the controller 40. The amplifier/filter 60 amplifies the output of the detection element 30 appropriately, and also can filter the output to eliminate “false alarms” and other signals that do not indicate an intrusion. When a signal indicating an intrusion is received, the controller 40 transmits an alarm signal to the relay 70 initiating an alarm, and also lights an alarm indicator light 80 as further indication that the alarm has been tripped. The alarm signal can initiate alarms of many forms, for example an audible alarm emanating from the loudspeaker 50 for alerting others of the intrusion and/or repelling the intruder(s). The alarm signal can also be transmitted to remote locations such as local law enforcement centers, to further alert people to the intrusion.

The function selection circuit 90 allows operators of the alarm system 10 to switch between various modes of operation, such as modes in which an audible alarm is generated by loudspeaker 50, and “silent alarm” modes that do not enable the loudspeaker 50 but transmit the alarm signal to local law enforcement. Power to the alarm system 10 is typically supplied by a primary power supply such as a local power line, commonly employing a voltage regulator 100.

While often effective in detecting and/or deterring intrusions, alarms such as the alarm system 10 still suffer from drawbacks. For instance, in conditions of low ambient illumination, such as during nighttime or during a power failure, the alarm system 10 can alert others to an intrusion upon a location but, as the location is dark, the intruder cannot be spotted or identified. The alarm indicator light 80 is often remote to the location of the intrusion, and even if not, the alarm indicator light 80 is often a low-intensity light-emitting diode (LED) that serves only to signal the activation of the alarm. As such, it is typically much too faint to provide sufficient illumination for identifying intruders or intimidating them into abandoning their intrusion.

It is therefore desirable to provide an alarm system with an additional illumination feature, so that the location scanned/protected by the alarm can also be illuminated. Such added functionality would aid in identifying and repelling intruders.

### SUMMARY OF THE INVENTION

The invention can be implemented in numerous ways, including as a method, system, and device. Various embodiments of the invention are discussed below.

As an intrusion detection system, one embodiment of the invention comprises a detection element configured to detect an intrusion into a location. Also included is a controller in electrical communication with the detection element and configured to transmit an alarm signal upon detection of the intrusion by the detection element. Further included is an illumination source in electrical communication with the controller, the illumination source configured to illuminate the location upon detecting the alarm signal.

As an intrusion detection system, another embodiment of the invention comprises an alarm circuit configured to initiate an alarm upon an intrusion into a location, and a lighting circuit in electrical communication with the alarm circuit, and configured to illuminate the location upon the initiation of the alarm.

As a method of detecting an intrusion, another embodiment of the invention comprises providing a detection system for detecting an intrusion into a location, and for generating a signal in response to the detecting. This embodiment also comprises providing an illumination system coupled to the detection system, so as to illuminate the location upon receiving the signal.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For a better understanding of the invention, reference should be made to the following detailed description taken in conjunction with the accompanying drawings, in which:

FIG. 1 illustrates a block diagram of a conventional alarm system having an alarm circuit.

FIG. 2 illustrates a block diagram of an alarm system in accordance with embodiments of the invention, including both an alarm circuit and an illumination circuit.

Like reference numerals refer to corresponding parts throughout the drawings.

### DETAILED DESCRIPTION OF EMBODIMENTS OF THE INVENTION

The invention relates to an improved alarm system that has an added illumination feature allowing locations to be both scanned for intruders, and illuminated upon intrusion detection. This illumination feature imparts a number of advantages over current alarm systems. Notably, lighting the area where an intrusion is detected can aid in identifying the intruder and possibly even intimidating him/her into leaving, especially during night time or other conditions of low ambient light. Also, the illumination feature can be configured so as to be activated independent of the alarm itself. In this manner, light can be provided during emergencies or any other time that users require additional light. Use of such added illumination need not be restricted to intrusions.

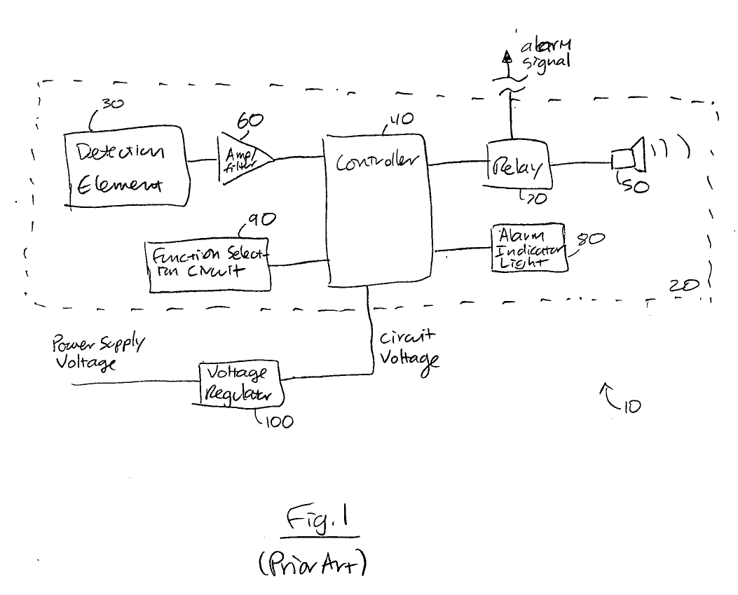

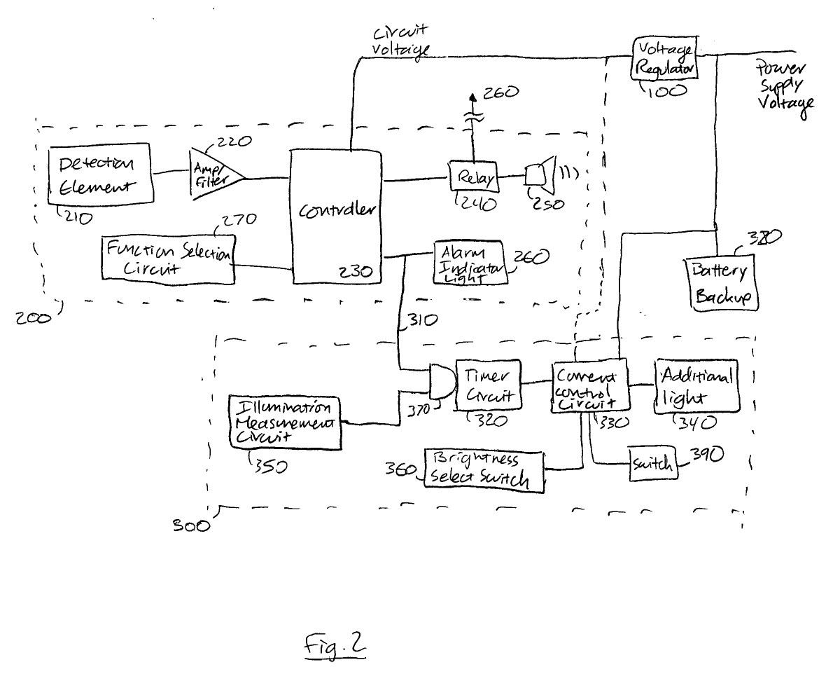

FIG. 2 illustrates a block diagram of such an alarm system that includes both an alarm circuit and an illumination circuit. Shown are an alarm circuit 200 that detects intrusion and triggers a resultant alarm, and an illumination circuit 300 for lighting the area where the intrusion occurred. The alarm circuit 200 can be any known alarm circuit for detecting intrusion. More specifically, the alarm circuit 200 can be configured and operated similarly to the alarm circuit 20 of FIG. 1. Thus, for example, detection element 210 can be placed so as to detect an intrusion upon a location, and send a resultant signal through the amplifier/filter 220 accordingly. This amplified/filtered signal alerts the controller 230 to the intrusion, whereupon the controller 230 transmits an alarm signal (sent through the relay 240) to the appropriate channels, such as loudspeaker 250 and remote line 260 to remote locations. The controller 230 also activates the alarm indicator light, commonly a relatively low-intensity LED that indicates an alarm condition.

The above described workings of alarm circuit 200 are known. In the present invention, alarm circuit 200 is coupled to the illumination circuit 300 for illuminating the area where the intrusion occurred. In operation, function selection circuit 270 is set to alarm mode. Upon an intrusion, illumination circuit 300 receives the alarm signal (transmitted from alarm circuit 200) across line 310, where it passes through timer circuit 320 to the current control circuit 330. Upon receiving the alarm signal, the current control circuit 330 illuminates the additional light 340, which is placed so as to illuminate the area where the detection element 210 detects an intrusion. In this manner, when the detection element 210 senses an intrusion upon the particular location it is monitoring, an alarm signal is triggered. This alarm signal activates traditional alarms, such as the loudspeaker 250 and alarm indicator light 260, and also activates the additional light 340 so as to illuminate the area even further. This additional light can often aid in deterring and/or identifying intruders, especially in low-light conditions such as night times. The additional light 340 can be any device for providing sufficient additional light, such as known incandescent or fluorescent lights, high-intensity LEDs, and the like.

The battery backup 380 provides backup power to the illumination circuit 300, and can also be configured to provide backup power to the alarm circuit 200 in the event of a failure of the regular power supply. Thus, the system of FIG. 2 can continue to detect intrusions even in the event of power failures. Notably, the backup 380 allows for illumination by the additional light 340 even during power failures or emergencies, so that none of the functionality of the system of FIG. 2 is compromised. The backup 380 is shown as a battery backup, but the invention encompasses the use of any device that is capable of supplying backup power to an electrical system.

Other features of the illumination circuit 300 confer various additional advantages. For example, illumination measurement circuit 350, which can be any known device for measuring a level of ambient light, such as a photodetector, is placed and configured so as to measure the ambient illumination level of the location to be illuminated. Gate 370 thus allows the illumination measurement circuit 350 to detect the level of ambient illumination at the intrusion location, and to disable the additional light 340 when it is not necessary. In this manner, the illumination function of the circuit 300 can be disabled during daytime or other times when sufficient levels of ambient illumination already exist, thus conserving electrical power. In other words, the illumination circuit 300 can perform its illumination function selectively, at certain times and not others, so as to conserve power.

In one embodiment, the illumination measurement circuit simply detects the level of ambient illumination and compares it to a minimum threshold of ambient light. If the level of detected illumination is above this threshold (i.e., if the location of potential intrusion is already well-lit), the additional light 340 is disabled, whereas if the level is below the threshold, the light 340 is lit when an intrusion occurs. In another embodiment, the timer circuit 320, which can be any device for keeping track of time, can be set to note the time of day/night, and to disable/enable the additional light 340 accordingly. Thus, the circuit 300 can disable its additional light 340 during day times (e.g., from 9:00 a.m. to 5:00 p.m.), and re-enable its function during night times. One of skill will realize that the invention encompasses the use of any magnitude of the threshold discussed above. Likewise, the invention encompasses the disabling/re-enabling of illumination according to any time(s) deemed appropriate by the user.

In addition to being disabled/enabled according to time or level of ambient light, the illumination circuit 300 can also be controlled more finely, so as to provide illumination at a level related to the level of ambient light. More specifically, the brightness select switch 360 can be employed to modulate the intensity of the additional light 340 so that it provides additional illumination in an amount tied to the level of ambient light. Thus, the illumination circuit 300 can be set to light up a particular area to varying degrees depending on how much light is already present—more in dim light, and less in strong light such as broad daylight.

It should be noted that the presence of the additional light 340 need not be used exclusively in response to an intrusion. Rather, it can be used to illuminate an area in other circumstances where additional light is desired, such as in various emergency situations or simply when more light may be wanted. Thus, the additional light 340 confers the added advantage of supplying more light whenever it is desired. To that end, function selection circuit 270 can be configured to set the controller 230 to multiple modes. One such mode can be a conventional alarm mode, where an alarm is triggered and the additional light 340 is lit upon an intrusion. Another such mode can be simply an “additional light desired” mode, where the additional light 340 can be activated in the absence of an intrusion, whenever more light is desired.

In yet another mode, the alarm circuit 200 detects motion but triggers the additional light 340 instead of the alarm. In this mode, the alarm circuit 200 acts as a motion-triggered light, and not an alarm, automatically lighting the light 340 for passers-by when more light is desired, such as during night time. In this mode, the alarm circuit 200, which becomes essentially a detection system instead of an alarm system, can be used to illuminate a hallway of a dwelling at nighttime without triggering an alarm. In a related mode, the light 340 can be activated by emergency conditions such as upon detection of a fire alarm signal, so that occupants of a burning dwelling can more easily escape to safety at night times.

Of course, the invention is not limited to the providing of such additional light only via preset modes within the alarm circuit 200. Another implementation may involve simply providing a switch 390 that allows users to activate the light 340 whenever they want. Thus, for example, the current control circuit 330 can be configured to activate the additional light 340 upon an illumination request signal from the switch 390, or from the controller 230 via the function selection circuit 270.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, any light can be used as an additional light 340 so long as it sufficiently illuminates potential intrusion locations. Similarly, the illumination circuit 300 containing the light 340 can be configured in many different ways, to provide illumination during intrusions and other times, to be disabled at certain times in order to save power, and to run off backup power when necessary. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An intrusion detection system, comprising:
a detection element configured to detect an intrusion into a location;
a controller in electrical communication with the detection element and configured to transmit an alarm signal upon detection of the intrusion by the detection element; and
an illumination source in electrical communication with the controller, the illumination source configured to illuminate the location upon detecting the alarm signal.

2. The intrusion detection system of claim 1 further comprising an illumination measurement circuit in electrical communication with the illumination source and configured to detect an ambient illumination level of the location, wherein the illumination source is further configured to illuminate the location according to the ambient illumination level.

3. The intrusion detection system of claim 2 wherein the illumination measurement circuit is further configured to detect a minimum threshold of the ambient illumination level, and wherein the illumination source is further configured to selectively illuminate the location upon detecting the alarm signal and a magnitude of the ambient illumination level that is below the minimum threshold.

4. The intrusion detection system of claim 1 further comprising a timer circuit in electrical communication with the illumination source and configured to determine a time, wherein the illumination source is further configured to illuminate the location according to the time.

5. The intrusion detection system of claim 4 wherein the timer circuit is further configured to determine a night time characterized by a low amount of ambient illumination of the location, the illumination source configured to selectively illuminate the location upon detecting the alarm signal during the night time.

6. The intrusion detection system of claim 1 wherein the controller is further configured to receive an illumination request signal requesting illumination of the location, and to direct the illumination source to illuminate the location in response to the illumination request signal.

7. The intrusion detection system of claim 6 wherein the illumination request signal is an emergency illumination request signal requesting illumination of the location during an emergency.

8. The intrusion detection system of claim 1 further comprising a backup power supply in electrical communication with the illumination source, wherein the illumination source is configured to draw electrical power from a primary power supply so as to illuminate the location and is further configured to draw electrical power from the backup power supply so as to illuminate the location upon a failure of the primary power supply.

9. The intrusion detection system of claim 1 wherein the detection element is a PIR detector.

10. The intrusion detection system of claim 1 wherein the detection element is a microwave detector.

11. The intrusion detection system of claim 1 wherein the detection element is a photo beam detector.

12. The intrusion detection system of claim 1 wherein the detection element is a glass break sensor.

13. The intrusion detection system of claim 1 wherein the detection element is a door contact sensor.

14. An intrusion detection system, comprising:
an alarm circuit configured to initiate an alarm upon an intrusion into a location; and
a lighting circuit in electrical communication with the alarm circuit, and configured to illuminate the location upon the initiation of the alarm.

15. The intrusion detection system of claim 14 wherein the lighting circuit further comprises an illumination measurement circuit in electrical communication with the illumination source, the illumination measurement circuit configured to detect an ambient illumination level of the location, and wherein the lighting circuit is further configured to control the magnitude of light emitted by the lighting circuit according to the ambient illumination level.

16. The intrusion detection system of claim 15 wherein the illumination measurement circuit is further configured to detect a minimum threshold of the ambient illumination level, and wherein the illumination source is further configured to selectively illuminate the location upon detecting the initiation of the alarm and a magnitude of the ambient illumination level that is below the minimum threshold.

17. The intrusion detection system of claim 14 wherein the lighting circuit further comprises a timer circuit configured to determine a time, and wherein the lighting circuit is further configured to control the magnitude of light emitted by the lighting circuit according to the time.

18. The intrusion detection system of claim 17 wherein the timer circuit is further configured to determine a night time characterized by a low amount of ambient illumination of the location, and wherein the lighting circuit is further configured to selectively illuminate the location upon detecting the alarm signal during the night time.

19. The intrusion detection system of claim 14 wherein the lighting circuit is further configured to illuminate the location in response to receiving an illumination request signal requesting illumination of the location.

20. The intrusion detection system of claim 19 wherein the illumination request signal is an emergency illumination request signal requesting illumination of the location during an emergency.

21. The intrusion detection system of claim 14 further comprising a backup power supply in electrical communication with the lighting circuit, wherein the lighting circuit is configured to receive electrical power from a primary power supply so as to illuminate the location and is further configured to receive electrical power from the backup power supply so as to illuminate the location upon a failure of the primary power supply.

22. The intrusion detection system of claim 14 wherein the alarm circuit further includes a PIR detector.

23. The intrusion detection system of claim 14 wherein the alarm circuit further includes a microwave detector.

24. The intrusion detection system of claim 14 wherein the alarm circuit further includes a photo beam detector.

25. The intrusion detection system of claim 14 wherein the alarm circuit further includes a glass break sensor.

26. The intrusion detection system of claim 14 wherein the alarm circuit further includes a door contact sensor.

27. A method of detecting an intrusion, comprising:
providing a detection system for detecting an intrusion into a location, and for generating a signal in response to the detecting; and
providing an illumination system coupled to the detection system, so as to illuminate the location upon receiving the signal.

28. The method of claim 27 wherein the providing an illumination system further comprises providing an illumination system configured to illuminate the location upon the detecting, and upon the determination of a night time.

29. The method of claim 27 wherein the providing an illumination system further comprises providing an illumination system configured to illuminate the location upon the determination of an emergency condition.

30. The method of claim 27 further comprising providing a backup power supply coupled to the illumination system, wherein the illumination system is configured to receive electrical power from a primary power supply so as to illuminate the location and is further configured to receive electrical power from the backup power supply so as to illuminate the location upon a failure of the primary power supply.
